(19) United States
(12) Patent Application Publication
(10) Pub. No.: US 2017/0177801 A1
(43) Pub. Date: Jun. 22, 2017

(54) DECISION SUPPORT TO STRATIFY A MEDICAL POPULATION

(71) Applicant: CERNER INNOVATION, INC., Kansas City, KS (US)

(72) Inventors: HUGH H. RYAN, LEE'S SUMMIT, MO (US); PHILLIP M. STADLER, OLATHE, KS (US)

(21) Appl. No.: 15/381,404

(22) Filed: Dec. 16, 2016

Related U.S. Application Data
(60) Provisional application No. 62/269,537, filed on Dec. 18, 2015.

(51) Int. Cl. G06F 19/00

(52) U.S. Cl. CPC G06F 19/324; G06F 19/345; G06F 19/3431

(57) ABSTRACT

A cloud-based system provides stratification of a medical population to facilitate the most efficient use of health intervention resources to improve the health of individual patients. The system can stratify coarse cohorts to identify patients with high management risk and/or high impactability. The system can recommend health service workflows for a particular patient. The system can use medical, community, and social data to better identify health service workflows appropriate for an individual and avoid missed opportunities to improve the health of highly impactable patients.

### CROSS-REFERENCE TO RELATED APPLICATION

This application claims the benefit of U.S. Provisional Patent Application No. 62/269,537, filed Dec. 18, 2016, which is hereby incorporated by reference in its entirety.

### TECHNICAL FIELD

The present disclosure relates to methods and systems for stratifying a medical population.

### BACKGROUND

Population Health Management (PHM) describes a variety of tools and strategies used with the goal of maintaining health in a patient population to avoid unnecessarily expensive interventions, such as emergency room visits for chronic or avoidable conditions. PHM aims to prevent illness or the exacerbation of illness, and, therefore, tries to identify individuals who might benefit from proactive health interventions such as modified medical treatments, prophylactic medical treatments, lifestyle modifications, health coaching, and the like. PHM starts with segregating patients into groups, such as a group of people with diabetes.

### BRIEF SUMMARY

This brief summary is meant to present an overview of concepts related to this disclosure, and is expressly not meant to define or identify key elements of the disclosure in isolation from the remainder of the disclosure, including the figures.

Conventional PHM systems can reliably segment patient populations into coarse groups or cohorts, e.g., by a single diagnostic code. However, decisions about how best to influence specific individuals within a coarse cohort of patients have conventionally been left to clinicians' best guesses, leading to inefficient utilization of resources (e.g., devoting intervention resources to individuals unlikely to benefit from the intervention), selection bias, and unnoticed opportunities (e.g., failing to devote intervention resources to individuals likely to benefit from the intervention). Outreach programs for patients may fail to distinguish between individuals within coarse segments, again leading to inefficient utilization of resources. The present disclosure generally relates to methods and systems for identifying potentially high-impact health interventions. In particular, the present disclosure relates to methods and systems for stratifying a medical population, with the goal of enabling appropriate health care planning and services for individual patients. Stratification Decision Support (SDS) may employ multiple individual algorithms and models, sequenced to provide relevant stratification of larger groups or cohorts.

In some aspects, SDS may use clinical and non-clinical attributes to stratify a coarse cohort, such as individuals experiencing a particular disease type, individuals with a certain healthcare cost profile, or individuals with like locations. The SDS may use sequential logic, allowing the SDS to reach multiple, flexible outcomes even for the same individual, as when clinical and/or non-clinical attributes of the individual vary with time. The SDS may calculate a patient's current disease burden. The SDS may calculate a patient's projected disease burden. The SDS may assess the management risk for a patient. Management risk may be assessed by health system utilization, by quality measures, or both. The SDS may use calculations of past healthcare expenditures. The SDS may use calculations of projected healthcare expenditures.

The SDS may apply different logic steps in sequence to stratify a coarse cohort. Doing so may help eliminate waste, improve consistency in the deployment of resources, and advance compliance with wellness or treatment regimens, by supporting decisions about how best to utilize limited resources for health interventions. Notably, the SDS does this not by attempting to automate the decision-making process deployed by clinicians, which is generally intuitive and prone to selection bias, but by utilizing a novel decision support pathway having sequential logic steps that provide both flexibility and objectivity in assessing the likely value of a particular health intervention for a particular individual. By stratifying or individualizing a population, limited resources can be directed to those individuals or sub-segments most likely to benefit from a particular health intervention and/or those likely to benefit the most from a particular health intervention.

With regard to the technical functioning of the computer network on which the SDS system operates, the deployment of sequential logic may also reduce the bandwidth required for network communications and the processing power required to assess a patient's record. As an example, in a networked or cloud-based system, where an SDS system is pulling data from and/or pushing data to a variety of remote computers, using sequential logic allows the SDS system to pull limited data as it is needed. Sequential logic also allows the system to perform limited recalculation as data changes (e.g., over time or due to record corrections) or new data becomes available (e.g., previously unavailable laboratory test results or physical examination observations are made available on the network). Using sequential logic also allows the system to generate helpful-but-incomplete assessments if some relevant data is unavailable or out-of-date.

Additional objects, advantages, and novel features of the disclosed concepts will be set forth in part in the description which follows, and in part will become apparent to those skilled in the art upon examination of the following, or may be learned by practice of the disclosure.

### BRIEF DESCRIPTION OF THE SEVERAL VIEWS OF THE DRAWING

The present disclosure makes reference to the attached drawing figures, wherein:

FIG. 1 is an overview of an exemplary method for stratifying a medical population in accordance with aspects of the disclosure;

FIG. 2 is an exemplary logic flow for sequential operations related to estimating the current burden of an individual on a healthcare system in accordance with aspects of the disclosure;

FIG. 3 is an exemplary logic flow for sequential operations related to estimating the projected burden of an individual on a healthcare system in accordance with aspects of the disclosure;

FIG. 4 is an exemplary logic flow for estimating management risk and applying an impactability model in accordance with aspects of the disclosure;

FIG. 5 is an exemplary logic flow for estimating the impactability of an individual in accordance with aspects of the disclosure;

FIG. 6 is an exemplary graph of complexity vs. wellness in accordance with aspects of the disclosure;

FIG. 7 is an exemplary graph of engageability cohorts by engagement score and health score in accordance with aspects of the disclosure;

FIG. 8 is a schematic view of an exemplary stratification system in accordance with aspects of the disclosure; and

FIG. 9 is a schematic view of an exemplary computing system useful for implementing embodiments of the disclosure.

### DETAILED DESCRIPTION

As used herein, “health” may refer to traditional, Western-style “healthcare,” which includes preventative exams and testing, prophylactic treatments and/or medications, therapeutic treatments and/or medications, palliative treatments and/or medications, and the like. As used herein, “health” may also refer to wellness-related activities or decisions, including dietary choices, dietary supplementation, day-to-day physical activity (as distinguished from physical activity undertaken with the supervision of a licensed health care provider, such as a physical therapist), and the like.

As used herein, “healthcare providers” are providers, typically licensed, who provide clinical services, such as physicians, radiologists, pathologists, audiologists, nutritionists, dieticians, psychologists, psychiatrists, mental health counselors, nurses, nurse practitioners, physician assistants, medical assistants, chiropractors, massage therapists, acupuncturists, and the like. “Health-related providers” are providers who may or may not be licensed, such as personal (physical) trainers, exercise instructors or coaches, some health coaches (a registered nurse or other licensed professional might also serve as a health coach), chefs, home health assistants, and others who may provide health-related information, encouragement, modeling, tracking, and the like, but do not provide medical or clinical services per se. As used herein, “health service providers” include healthcare providers and health-related providers.

As used herein, “health intervention” includes medical advice and medically advised activities, treatments, medications, and the like, intended to prevent, ameliorate or cure an undesirable health condition. Unless specified as a “medical health intervention”, “health intervention” also includes “wellness interventions”, which include advice and activities intended to maintain or promote wellness, such as coaching or encouragement to make healthy lifestyle choices related to diet, physical activity, and the like. Health interventions include some activities which might be medical health interventions and/or wellness interventions, such as routine, preventative health screenings for body mass index.

All steps and flowcharts described herein, including in the attached figures, are meant to be illustrative. It should be understood that other steps may be used with the illustrated steps, and, further, that some steps may be useful without the practice of other steps included in the figures. The illustrated sequence of steps is also exemplary, and, unless described otherwise, the steps may be performed in different sequences, combinations, and/or subcombinations.

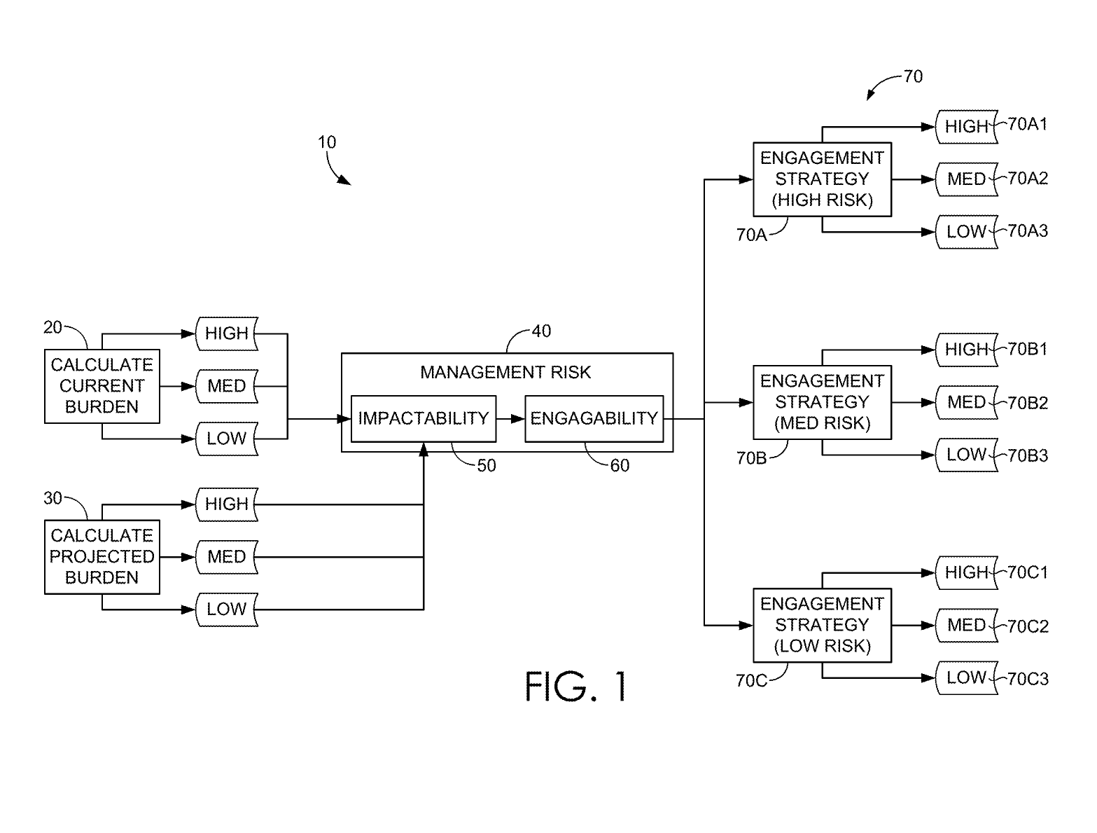

As shown in FIG. 1, an exemplary SDS flow 10 may involve the application of sequential logic to stratify a coarse segment or cohort of individuals. A coarse segment or cohort may, for example, be defined based on current health state (e.g., generally well or generally not-well), current health condition (e.g., diabetic, pre-diabetic, hypertensive, obese, overweight, etc.), geographic location (e.g., state, county, zip code, or neighborhood), or location within a health care institution (e.g., emergency department, intensive care unit, surgical unit, infectious disease unit, labor and delivery unit, etc.). Geographic location may influence a variety of health-related decisions. Geographic location may, for example, affect the availability of healthcare services, the availability of health-related services, the varieties of physical activities safely and readily available (as may be influenced by climate), or the availability and/or quality of certain kinds of foods (such as fresh produce, fresh seafood, or culturally familiar cuisine).

The stratification may help to further distinguish individual needs and tendencies within the coarse segment or cohort, as the coarse segment or cohort may include several subpopulations and/or unique individuals. The coarse segment or cohort may be defined based on a single attribute (e.g., diabetic) or on a small number of defining attributes, such as two or three or four or five defining attributes (e.g., diabetic and hypertensive, or diabetic and hospitalized, or diabetic and hospitalized in Missouri, USA). These limited definitional attributes leave room for a wide variety of individual circumstances within the coarse cohort, such that targeting health interventions to a coarse cohort may result in both under-utilization and over-utilization of resources, e.g., lack of meaningful participation in an intervention by an individual who would benefit from an intervention, or participation in an intervention by individuals who are less likely to benefit from the intervention than they would from other interventions, or than other individuals would benefit from the same intervention. These differences in need, tailoring, and efficacy can be significant for an individual, and are systemically significant when accumulated over many individuals.

FIG. 1 does not identify the coarse cohort being stratified, as the coarse cohort is not necessarily important to the sequence of logic flows used to stratify the coarse cohort. For example, SDS flow 10 might begin with burden calculations 20, 30 regardless of whether the coarse cohort relates to a health state, health condition, location, or other coarse segmentation. SDS flow 10 is applied by a computerized system to information available about an individual within the coarse cohort to be stratified.

Information about an individual may be derived from a questionnaire presented to the individual, from a medical record, from a record of a health-related service, from social media applications, and/or from other sources, either within the system executing the SDS flow 10 or external to the system but accessible by the system, or from combinations of these sources. The information about the individual may be accessible to a cloud-based system executing SDS flow 10, and may be retrieved at least in part from a Health Information Technology (HIT) system or component thereof, such as an Electronic Medical Record (EMR). Other exemplary sources of information include the individual (e.g., via oral or on-screen interview), a clinic or healthcare provider, a hospital, an outpatient care center, a medical device (whether used in an institution or at home, and whether data from the medical device is downloaded automatically, on-command, wirelessly, or via a physical connection to a network or computing device), a Health Information Exchange (HIE—a system for sharing patient information electronically across different organizations and/or HIT systems), a payer, a pharmacy, a post-acute care facility, a health-related service provider, and community sources.

Community sources may include, for example, aggregate population information based on a patient's zip code or neighborhood, including information about the patient's environment and interactions, either inferred from other data in the patient's file (such as zip code) or provided by the patient, caregiver, healthcare provider, or other service provider. Social sources may include, for example, information gleaned from social media websites or applications, patient-provided data about social activities, or other information about the patient's social environment and interactions, either inferred from other data in the patient's file or provided by the patient, caregiver, healthcare provider, or other service provider. Community and/or social sources may enable the system to draw inferences about a patient's resources and ability to participate in particular health interventions. For example, from an address or zip code, the system may access public databases regarding housing density, average income, transportation services, retail establishments, etc., that may be relevant to a patient's ability to keep appointments, obtain supplies for self-care, or otherwise fully participate in a health intervention. The system may request confirmation of inferences drawn from community and/or social sources, e.g., in patient surveys or interviews.

Exemplary types of information may include health insurance claims, clinical data (as may be stored in an EMR or shared in a questionnaire), wellness and/or biometric data, satisfaction data (such as survey responses regarding individual experiences with prior health interventions or services), and molecular information (e.g., genomic, proteomic, or other test information, whether qualitative or quantitative). These data may be collectively transformed into a longitudinal record, which may track the same or similar information over time; a longitudinal plan, which may set forth intended future check-ups, interventions, expected condition or state over time, and the like; databases, which may be private or secured to individuals with a need-to-know, and may be queried for information relevant to an individual; and/or de-identified databases, which may provide collective information about the coarse cohort or segments of the coarse cohort, and may help stratify the coarse cohort.

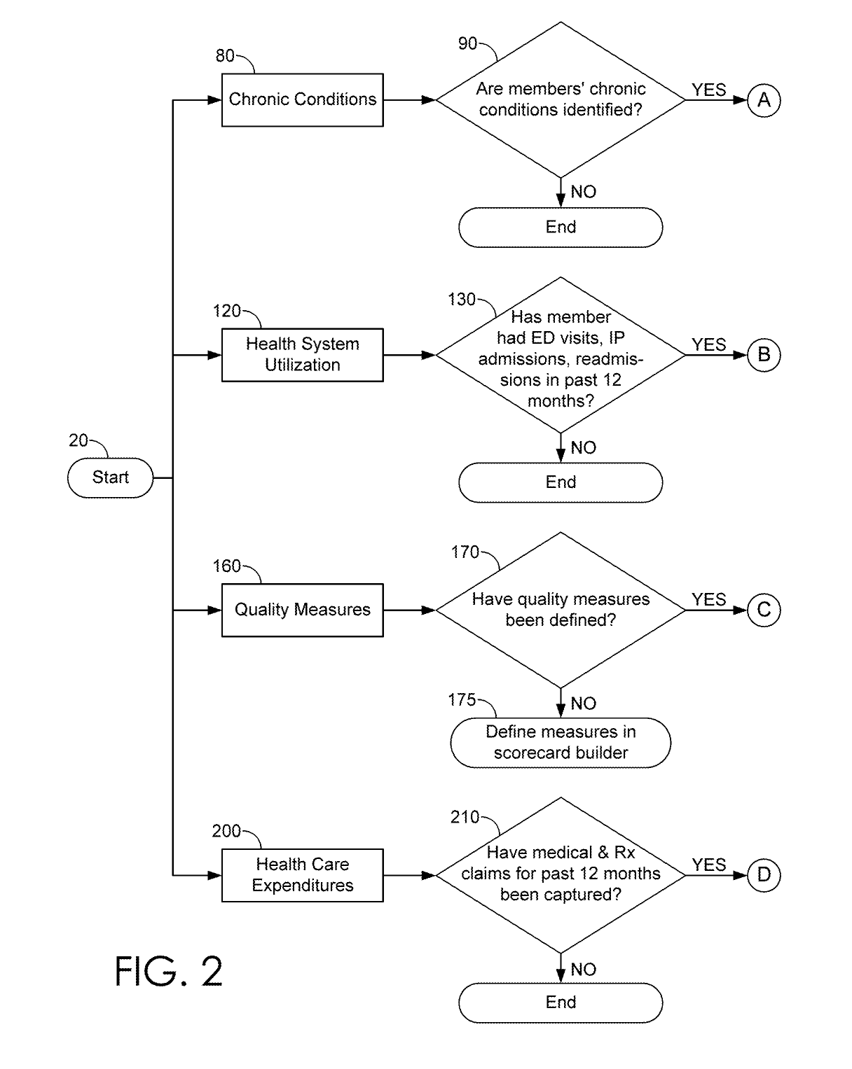

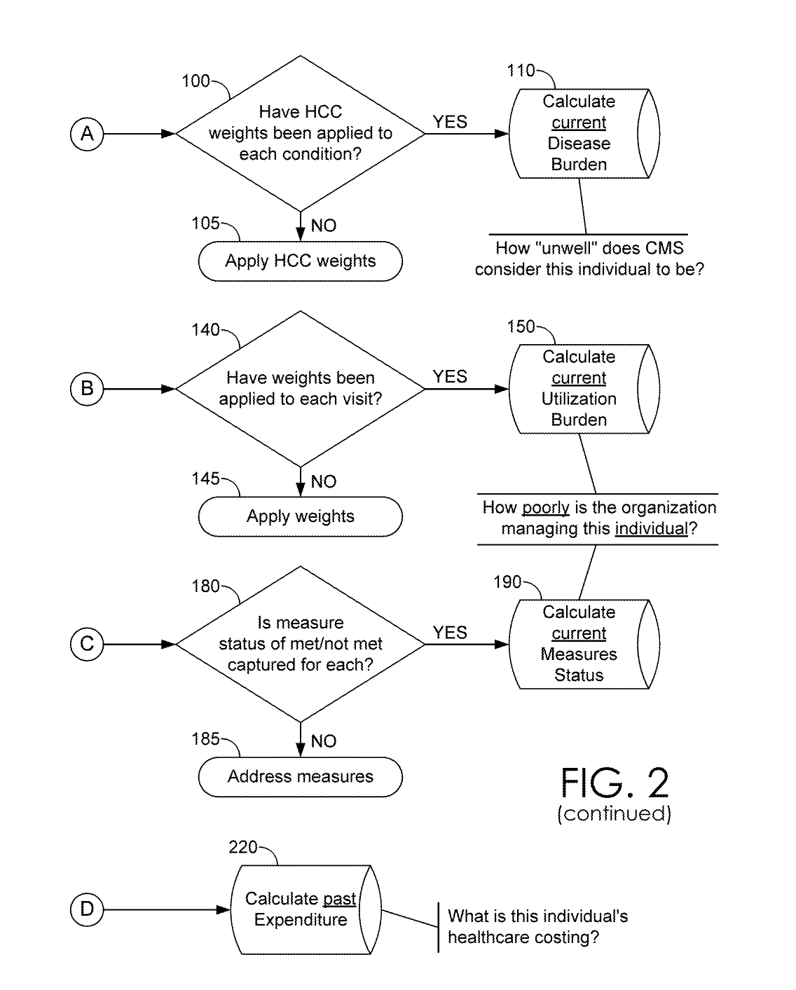

SDS flow 10 may include a calculation of an individual's current burden 20 on a healthcare delivery system. The calculation of current burden, an example of which is shown in FIG. 2, may consider one or more of chronic conditions 80, health system utilization 120, quality measures 160, and healthcare expenditures 200.

Chronic conditions 80 may be assessed by inquiring whether the individual has any current diagnoses, shown as step 90. Current diagnoses may be identified, for example, based on information obtained from the individual, from a healthcare provider, or from an EMR, HIT system, or HIE system. The current diagnoses may be identified, for example, based on natural language descriptions, standardized diagnostic codes, payer or institution codes, test results or examination findings determinative of a diagnosis, treatments or medications indicative of a diagnosis, or any other indication of a diagnosis in the information about a patient. Where records have different formats, codes, or ontologies, an ontology mapper may be used to link related concepts from different records. An exemplary ontology mapper is described in U.S. Pat. No. 8,856,156, which is herein incorporated by reference in its entirety.

If no current diagnoses are identified, the chronic condition component of the current burden is low or zero. If current diagnoses are identified, the system looks for hierarchical condition categories (HCC) for each current diagnosis at step 100. If unavailable, HCC weights are applied at step 105. The chronic condition component of the current burden is then calculated considering both the diagnosis or diagnoses, and the HCC weights for each diagnosis. Exemplary HCC weights are suggested by the Centers for Medicare & Medicaid Services (CMS) of the U.S. government. HCC weights are determined by CMS with reference to expected health costs associated with a condition, and may be used as a rough proxy for how well or unwell an individual is. Industry- or institution-developed weights could be used instead of or in addition to weights suggested by governmental (e.g., CMS) or non-governmental (e.g., World Health Organization) entities.

Health system utilization 120 may be assessed by inquiring whether the individual has visited an emergency department (ED), been admitted to a medical institution for in-patient (IP) care, or has been readmitted to a medical institution for in-patient care, as shown at step 130. This inquiry may be limited to a particular time period, such as the last 6 months, or the last year, or the last 2, or 3, or 5 years. At step 140, for each emergency department visit, admission, or readmission within the specified time frame, the system looks for a weight factor for the occurrence. Weight factors may be assigned based on, for example, whether the visit or admission was appropriate. For example, the system may look for diagnoses, treatments, medications, or other clinical orders placed during or shortly after the occurrence, to evaluate whether the occurrence seems to have been related to a need for the intense resources provided in an emergency department and/or in-patient setting, or whether the symptoms or condition that led to the occurrence might have been managed in other, more efficient ways. Weight factors may also be applied based on the nature of the occurrence (e.g., an unusual, “one-time” visit for an accidental injury, in contrast to a visit related to symptoms of a chronic condition or repeat visits/readmissions for the same or related symptoms); total cost of an occurrence; and/or the duration of an occurrence (e.g., how long a patient remained in the in-patient setting). Still other exemplary weight factors include prescription fill rates, number of emergency department visits, recidivism, readmission rates, and the like. Any or all of the weight factors could be used, alone or in combination or sub-combinations. High numbers of occurrences, especially with high weight factors, are an indication that the individual may have significant unmet health and wellness needs. Conversely, low numbers of occurrences or low-weight occurrences may indicate that the individual's health and wellness needs are reasonably satisfied.

Quality measures 160 may be assessed by first asking whether quality measures have been defined for a given condition, shown as step 170. Quality measures may be promulgated by regulators, industry organizations, or professional associations, such as the quality measures used by CMS, or may be internal standards developed by a particular healthcare delivery organization, payer organization (e.g., private medical insurance company) or the like. Quality measures may be used to objectively assess healthcare processes and outcomes, including patient experience, against best practices. One exemplary quality measure is adherence to mood stabilizers for individuals diagnosed with bipolar I disorder. Adherence is calculated as the percentage of adult individuals with bipolar I disorder at the beginning of the measurement period who are prescribed a mood stabilizer medication and adhere to the mood stabilizer medication for 12 consecutive months. Individual adherence, in turn, is a yes/no outcome measured as Proportion of Days Covered (PDC) of at least 0.8 over the 12 consecutive month measurement period. Adherence to mood stabilizers is one, exemplary, quality measure among many hundreds of quality measures listed in the CMS Measures Inventory at the time of this disclosure. Quality measures may involve calculated measures, but be reported as binary, yes/no results, e.g., whether an individual had a PDC of at least 0.8 over 12 months.

If quality measures have not been identified for a given condition, the system may seek to define measures in step 175. The definition of a new measure may initially rely on benchmarking (e.g., what most providers or patients do in a given set of circumstances) rather than data-based, outcome-driven measures (e.g., what has been empirically shown to be most efficient). Once quality measures have been defined, it is determined whether the measure status of met or not-met is present in the available information, at step 180. If met/not-met information is unavailable, additional information is sought in step 185. Seeking additional information may include providing a prompt or alert to a health service provider or individual user that additional information is needed. Alternately or in addition to alerting a human user, seeking additional information may include searching available records for relevant information and/or calculating a quality measure based on the best available data. At step 190, a cumulative quality measures score is calculated for an individual, taking into account all relevant quality measures for all relevant conditions applicable to the individual, or subsets of the relevant conditions applicable to the individual. Relevant measures and conditions may not reflect all known measures or conditions, but may be selected based on relative importance to overall health, policies of the organization hosting or using the SDS system or software, and the like.

The cumulative quality measures score, in combination with the current utilization burden calculated at step 150, together provide a measure of how well the organization is managing the individual's health. An individual, for example, with high utilization and low quality measures scores is being poorly managed. There could be many causal factors leading to high utilization and low quality measure scores, including, as examples, inappropriate services (utilization of unhelpful services, non-utilization of potentially helpful services, or both), a deteriorated health state (services unlikely to create noticeable change in condition), and/or failure to engage in recommended services (e.g., missed appointments, failure to comply with at-home or other self-guided regimens, etc.). In contrast, an individual with low to moderate utilization and high quality measures scores is probably being well managed.

At step 200, health care expenditures are considered. At step 210, medical and prescription costs for a predetermined time period are sought from the available information sources. Step 210 shows a system which looks for data for the preceding 12 months, however, different time periods can be used based on the preferences of the owner or user of the SDS system, such as 3 months, 6 months, 9 months, 15 months, 18 months, 21 months, 24 months, or longer. The time period over which cost data is considered may vary based on the rate of change in the individual's health system utilization. Cost data may be based on the amount billed to the patient, the amount billed to a patient's insurance company or other payer organization, the actual total cost of the patient's care, estimated or standardized costs for services and products reflects in the patient's records, or combinations or variations thereof. If cost data is unavailable, a prompt may be sent to a health service provider, payer, the individual, or another user or data source to request additional information. If cost data is available, past expenditures are calculated at step 220. Cumulative expenditures over the relative period help to assess what the individual's healthcare is costing the organization, individual, payer, or other, and can be used to compare outcomes from different care tracks. Other calculations may also be compared across different care tracks, to ensure that improvements in cost effectiveness are mirrored, for example, in improved quality measures. Step 220 may complete SDS flow 20 for calculating the current burden of an individual.

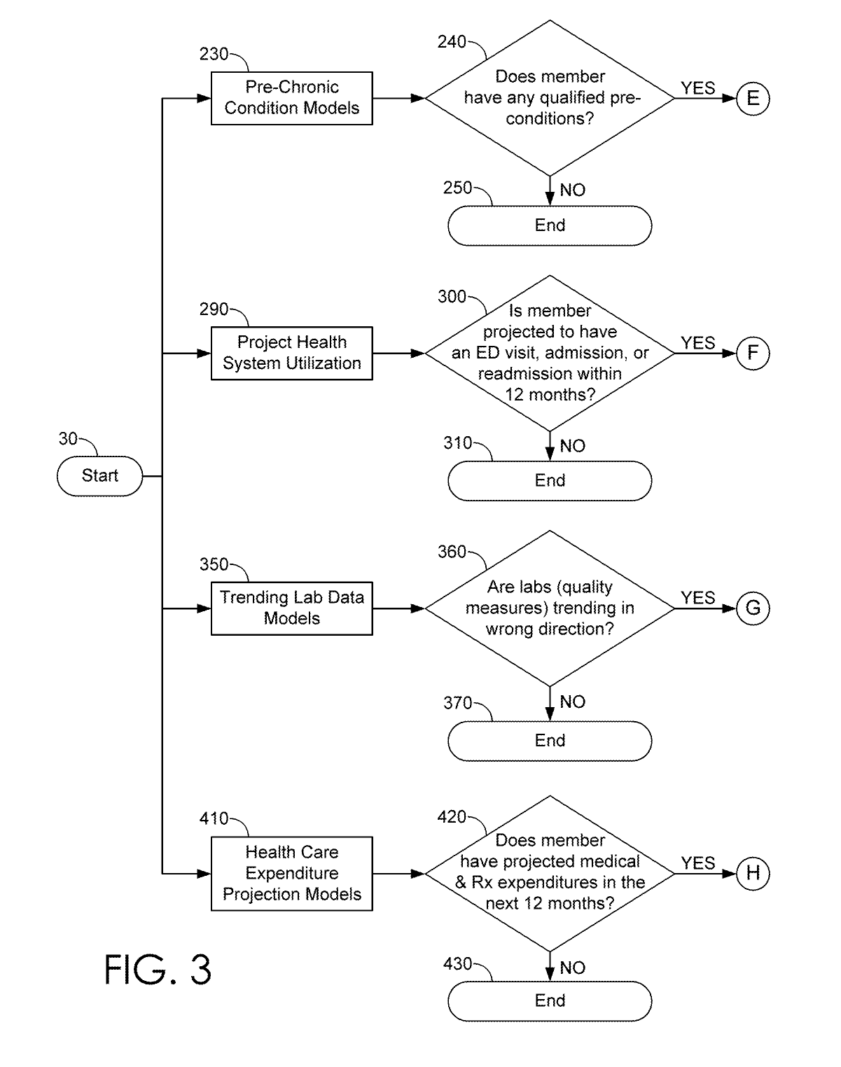

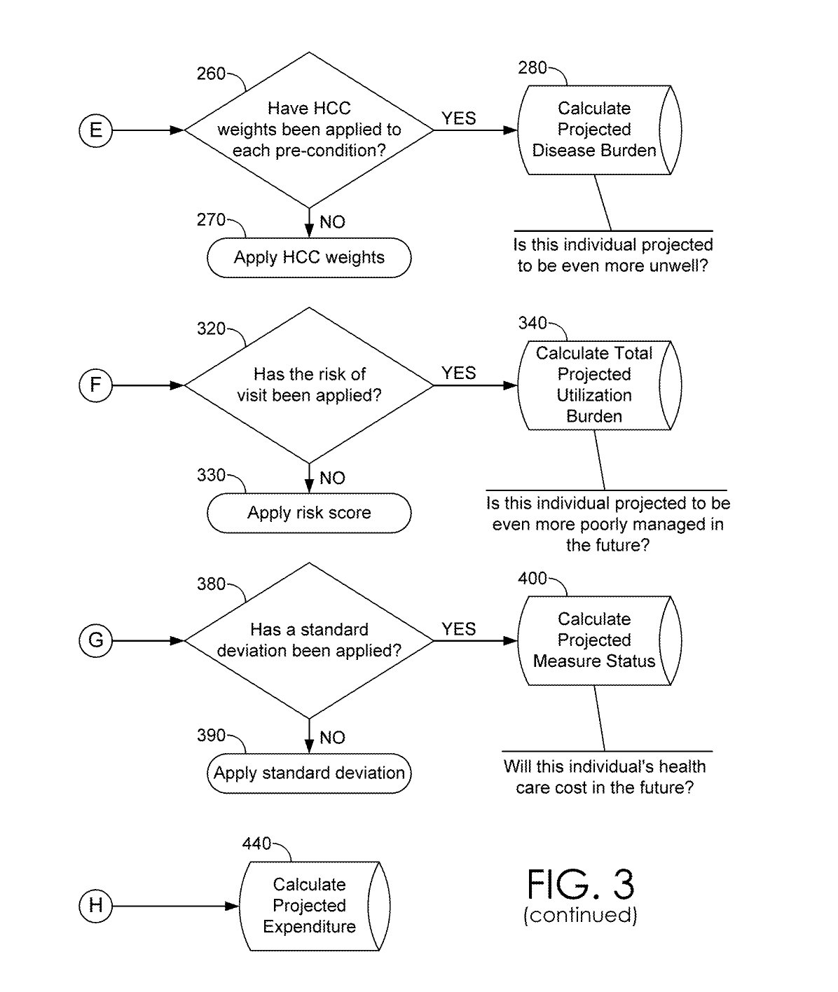

In addition to or as an alternative to calculating current burden in SDS flow 20, projected future burden may be calculated in SDS flow 30, shown in the exemplary flowchart of FIG. 3. At step 230, the available information is searched for indications of pre-chronic conditions. Models exist, for example, that predict whether an individual is likely to develop diabetes or heart failure based on, e.g., individual medical history, family medical history, biometric data—both current and longitudinal, and laboratory data—both current and longitudinal. At step 240, SDS flow 30 determines whether the individual has one or more relevant pre-conditions, as defined by the system owner or user. If no pre-conditions are identified, the pre-chronic conditions inquiry initiated at step 230 terminates at 250. If pre-chronic conditions are identified, at step 260 HCC weights, as described in relation to step 100, are sought and are applied at step 270. The outcome is calculation 280 of projected, future disease burden.

SDS flow 30 may include projected, future health system utilization, shown as step 290. At step 300, the system or software looks for information in the available data that may be indicative of an Emergency Department visit, in-patient admission, or in-patient readmissions within the next 12 months. Twelve months may be a suitable time frame for most estimations, however, if desired, the projected, future health system utilization may be calculated for shorter or longer periods, such as the next 3 months, 6 months, 9 months, 18 months, 21 months, 24 months, or longer. Data indicating unfavorable or unstable examination findings or laboratory test results, new patient complaints or patient complaints of increased severity, data trending at the edge of a critical range, or data trending in an unhealthy direction with an individual or family history of related disease, for example, may suggest the need for ED or in-patient care in the foreseeable future.

If a potential cause for future health system utilization is not identified, projection 290 terminates at 310. If a potential cause for future health system utilization is identified, a risk or probability level of the event is sought at 320. If no risk weighting has been applied, at 330 a risk weight is sought and, if available, applied. Predictive probabilities can be determined, for example, from historical data for other, similarly situated individuals, which may have been de-identified and aggregated for this purpose. Application of the risk weighting or risk score results in the total projected, future health system utilization 340.

SDS flow 30 may include an analysis 350 of trending lab data models. At step 360, the available data is searched for laboratory results trending in the wrong direction. If laboratory results are stable or trending in a favorable direction, analysis 350 terminates at 370. Otherwise, at step 380, a standard deviation is applied to the laboratory results, as a measure of how far the result is from the desired state. Monitoring the standard deviation from the mean over time can be used to calculate a rough approximation of projected, future laboratory result status, e.g., whether the observed trend is likely to continue or is sufficiently close to the desired state that it might be corrected back to “normal” or at least something more favorable.

SDS flow 30 may include a projection 410 of future healthcare expenditures. As step 420, a patient's projected medical expenditures, including, without limitation, medical and prescription medication costs, are projected for the next 12 months. Twelve months may be a suitable time frame for most estimations, however, if desired, the projected, future health system utilization may be calculated for shorter or longer periods, such as the next 3 months, 6 months, 9 months, 18 months, 21 months, 24 months, or longer. Projected medical expenses can be estimated, for example, by projecting the costs of continued use of chronic medications (such as statins, diabetes mellitus medications, or asthma treatments), as well as foreseeable costs related to predictable seasonal illnesses, acute conditions (such as pregnancy), or planned medical treatments (such as a scheduled surgery). If the individual has no projected medical expenses in the next 12 months, the projection ends at step 430. If the individual has projected medical expenses, they are estimated and summed at step 440.

The outcome of SDS flows 20 and/or 30 can be combined into an index value, the absolute value of which is non-essential, but which helps to distinguish patients relative to one another. The index values may be based on statistical populations, e.g., a standard deviation from the mean for the cohort, or on departures from an arbitrary goal for the population mean, or on other measures significant to the organizations and/or users using the system.

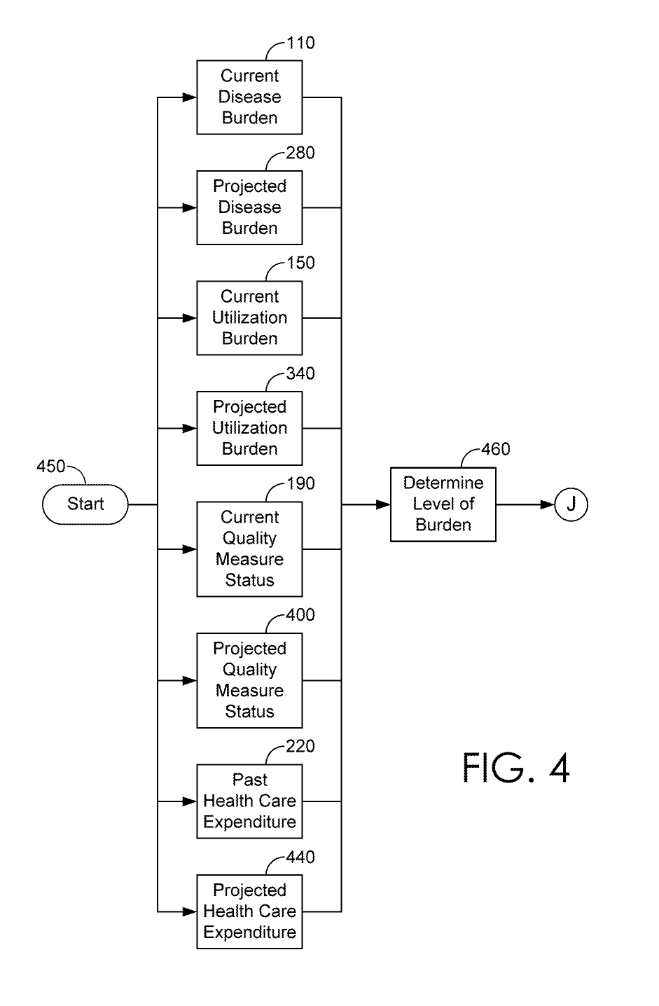

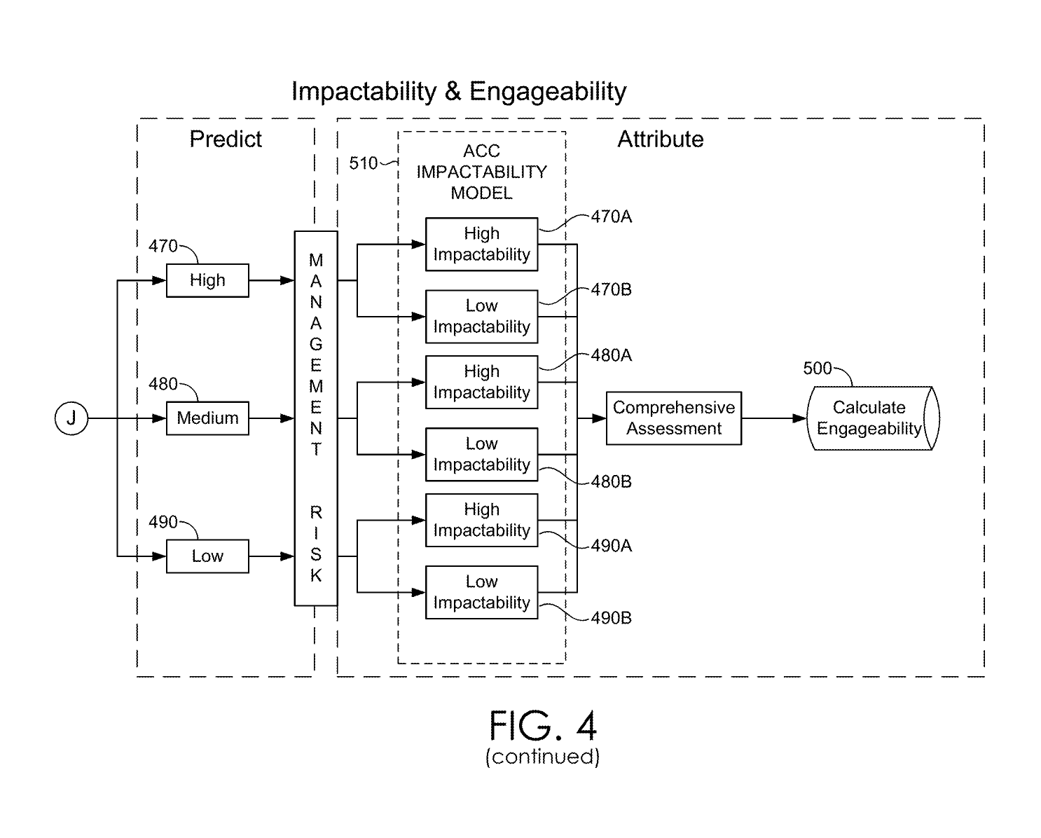

Index values for SDS flow 20 and/or SDS flow 30 may be used in flow 450 to determine, at step 460, the level of burden an individual places on a health system, and to predict whether the individual's future burden will be high, medium, or low, as shown in FIG. 4. This future burden provides one estimate of management risk 40, that is, of how well a health system is predicted to manage an individual's health. Individuals with high future burden 470 may not be served well or efficiently. Individuals with medium future burden 480 may be served moderately well, with room for improvement that is significant to the individual or cumulatively. Individuals with low future burden 490 may be served well—they may have few or no unmet health needs, and what needs they have are being met efficiently.

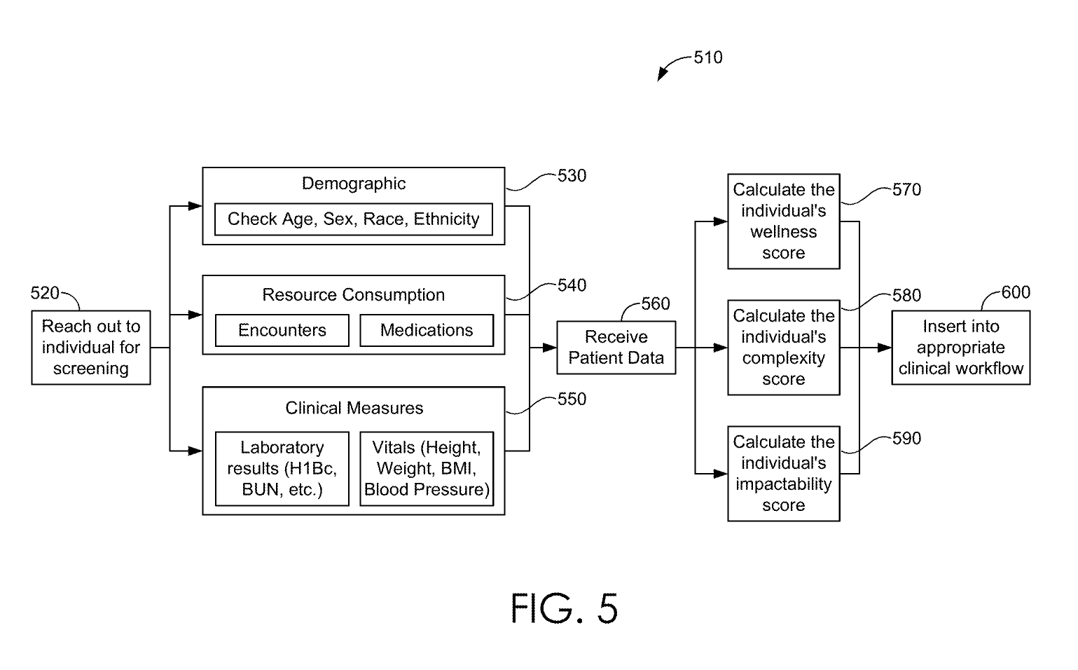

In addition to or instead of using projected future burden 30 as the sole estimate of management risk 40 for an individual, flow 450 may apply an impactability model 510, shown in greater detail in FIG. 5. Within each level of management risk (high, medium, and low), flow 450 may distinguish between high and low impactability sub-groups. In FIG. 4, high-risk, high-impactability individuals are identified with group 470A, high-risk, low impactability individuals are identified with group 470B, medium-risk, high-impactability individuals are identified with group 480A, medium-risk, low impactability individuals are identified with group 480B, low-risk, high-impactability individuals are identified with group 490B, and low-risk, low impactability individuals are identified with group 490B.

As shown in FIG. 5, impactability model 510 may comprise an individual screening process, 520. Individual screening process 520 may use a prior determination of individual attributes, such as health cohorts (e.g., cohorts based on diagnoses, risk factors, geography, etc.) to guide the screening content. In addition or alternatively, individual screening process may use information from SDS flows 20, 30 or similar to guide the screening content. The initial screening may be at least partially automated. That is, data of interest in the screening may be obtained from electronic medical records, prior patient interviews or surveys, and/or other accessible data sources. The initial screening may look for characteristics which prohibit healthcare tracking, such as lack of consent to access and track healthcare data, issues with informed consent (e.g., age less than age of majority, active mental health issues that would impair ability to consent), or other legal or administrative constraints. If the individual is eligible for healthcare tracking, impactability model 510 may request patient data from available sources, such as EHRs, other health service provider records, community information sources, social sources (either publicly available or with the patient's permission), and the like.

Individual screening process 520 may solicit demographic information 530, such as age, sex, race, and ethnicity; information about resource consumption 540, such as number of encounters and/or medications in the individual's medical history; clinical health measures 550, such as laboratory test results, observations of vital signs and statistics, and the like; and combinations thereof. The data may be solicited by individual screening process 520. For example, the screening process may involve automated, computerized searches of available records for the desired information. Alternately or in addition, the screening process may involve soliciting information from a human user, such as a service provider, patient, or an employee of a payer organization. Alternately or in addition, the screening process may involve recommending a workflow for a health service provider or inserting a workflow into an electronic system used by a health service provider for collecting or confirming certain data. Still alternately, other aspects of the SDS, HIT, or HIE system may push certain data to the individual screening process, such that data is received by impactability model 510, as shown at step 560, with or without an outgoing request.

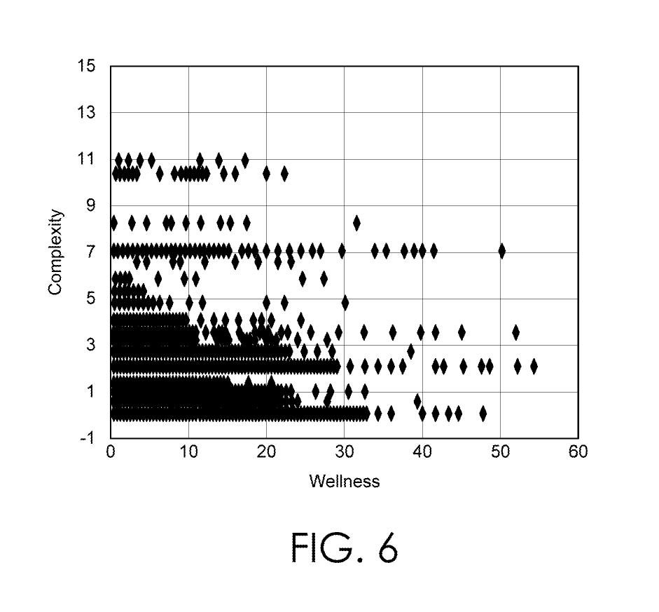

Data is received in step 560, and analyzed for one or more of wellness 570, complexity 580, and impactability 590. If sufficient data is available to calculate both a reliable wellness estimate and a reliable complexity estimate, impactability may be analyzed, for example, as a random subspace ensemble with regression trees. The analysis could be visualized as a graph with complexity plotted on the y-axis, with complexity increasing with increasing y-value, and wellness plotted on the x-axis, with wellness increasing with increasing x-value. This gives a visual cue as to how well an individual is relative to others in one or more similar medical cohorts, e.g., sharing at least one diagnosis, symptom, or other characteristic. Patients with low complexity and low wellness would have a high impactability score, reflecting that it should be relatively easy to discover and implement treatments or other interventions to improve such a patient's wellness. Patients with moderate or high complexity would tend to have somewhat lower impactability scores, reflecting that treatment of one or more conditions or symptoms may be constrained by other conditions or symptoms. Patients with moderate or high wellness would also tend to be less impactable than patients with low wellness, simply because they are already relatively well—any improvements in a high wellness patient are likely to be modest because the starting point of high wellness means there is less room for improvement. In contrast, a low-wellness patient has room for large wellness gains. Visually, on a chart like the one in FIG. 6, patients with high impactability would be represented as points near the origin, with impactability decreasing with increased distance in any direction from the origin.

If wellness or complexity cannot be calculated, one or the other may be used to give a very rough estimate of impactability by assuming the other is score is low, or is average for the cohort, or is some arbitrary score. The distance of the plotted point from the origin is still indicative of impactability, although the estimate might not be as reliable as if more information were available. Impactability may be revisited as additional data becomes available to the model. Impactability can be revisited automatically, e.g., on receipt of new data in systems where data is pushed to impactability model 510, or on a periodic schedule, such as once a year, or on a contingent schedule, such as on completion of a scheduled test, procedure, or examination. Impactability could also be revisited on user request. It should be appreciated that impactability can change over time. For example, a patient with high complexity could bring one or more co-morbidities under control, lowering the patient's complexity score and increasing impactability. As another example, a patient's wellness may decrease over time, creating larger room for gains and increasing impactability.

Impactability scores can be used to identify health service workflows, as shown at step 600. Exemplary workflows may include, for example, requests for more information (e.g., questions that can be posed to a patient or caregiver to obtain or confirm certain data about the individual); recommended tests; recommended examinations; or an alert that the patient has been identified as low, medium, or high impactability, with or without recommendations for specific follow-up. Alternately, or in addition, workflows, alerts and other information may be sent after an engageability score has been calculated at step 60. As used in this context, “sent” means prepared by the software for presentation to a human user, and may include presenting the data to a human user (e.g., via a visual, audio, or tactile presentation device connected to the user interface and the processor), or sending data for rendering in a human-readable format, as by any suitable user interface, including, without limitation, mobile devices, tablet computers, desktop computers, in-room displays, and the like.

Engageability calculation 60 may consider a variety of factors that predict the effectiveness of particular health interventions. These correlations may be drawn, for example, from statistical regression analysis of the health trajectories of other patients in the same or similar cohorts. In some cases, data may not be available for an individual's complete profile, i.e., for other patients having exact matches across all examined characteristics. However, data may be available indicating whether various aspects of an individual's engageability profile generally correlate to good, bad or neutral responses to various health intervention possibilities. Exemplary factors include a socioeconomic status index, a member activation score (a grouping based on level of engagement and activity within a healthcare organization or program), a readiness to change index, visit adherence, medication possession ratio, medication regimen complexity, geomapping, community/network resources, payer/plan preferences, language and/or cultural barriers, religious barriers, caretaker in home, cognitive deficits, behavioral health, substance abuse, and genomics. These factors may be evaluated based on patient interviews or self-reporting; health service provider reports or assessments; medical records (e.g., number and schedule of self-administered medications; diagnoses related to mental health, behavioral health, and/or substance abuse); databases of community health resources; databases of payer or health care organization resources, policies, or preferences; and the like.

The cumulative predicted engageability 60 of a particular patient in a particular context can be scored or indexed and used with impactability 50 to further refine predictions regarding whether an individual will respond favorably to a particular health intervention. It should be understood that engageability may vary somewhat in different contexts. For example, a particular individual may take one medical condition or risk factor more seriously than another condition or risk factor, and that may be reflected in the patient's willingness to undertake a complicated or inconvenient treatment regimen or readiness to change index. As another example, different potential health interventions for a particular condition may be available at differing distances from an individual patient, or at differing costs, particularly if the individual's payer organization will reimburse the patient for some possible health interventions and not others, or will reimburse the patient only for health interventions by certain providers. The availability, cost, and convenience of various services can also change over time even if there is no independent change in the patient's ability or willingness to participate in a health intervention.

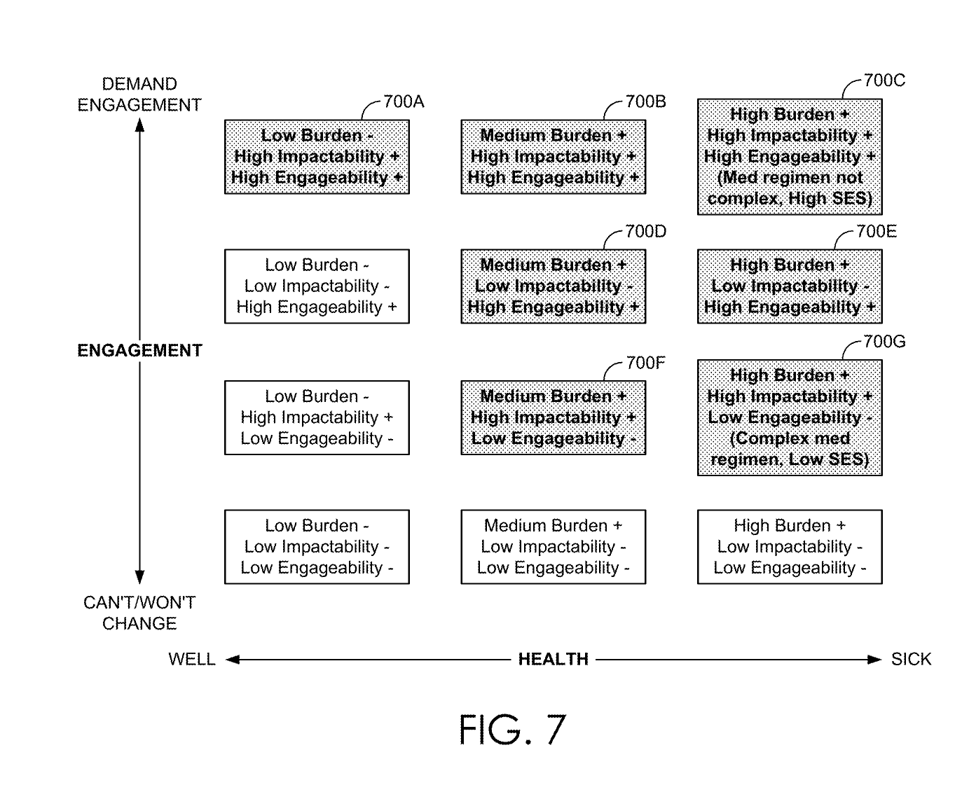

FIG. 7 shows an exemplary graph of engagement versus health. Blocks 700a-g represent groups with various combinations of burden, impactability, and engageability that make them attractive targets for health interventions. These are subpopulations that represent the highest opportunity to improve individual health with the lowest barriers to achieving health gains. As with impactability, the same individual might be represented by different blocks if assessed in different health cohorts or in relation to different possible health interventions. As such, the chart does not suggest that a given individual should or should not receive medical care or health intervention services. The chart suggests that some individuals will benefit more from particular kinds of care or prioritization of care than other individuals.

Impactability 50 and engageability 60, ideally taken together, inform management risk 40. Individuals can then be stratified based on high, medium, or low risk levels 70A, 70B and 70C, respectively. Each risk level can further be stratified by engageability, yielding high risk, high engageability group 70A1, high risk, medium engageability group 70A2, high risk, low engagement group 70A3, medium risk, high engageability group 70B1, medium risk, medium engageability group 70B2, medium risk, low engagement group 70B3, low risk, high engageability group 70C1, low risk, medium engageability group 70C2, and low risk, low engagement group 70C3. Each of the engageability groups 70A1-70C3 can then be associated with recommended health interventions (if any). Health service providers can exercise professional discretion in recommending or prescribing specific health interventions, but are given a framework to help them predict which individuals are most likely to benefit from a particular health intervention.

It should be understood that SDS flow 10, or steps or sub-flows within or associated with SDS flow 10, may be deployed for the same individual from different coarse cohorts, e.g., if an individual is diabetic and has cancer, or has a history of mental illness and is obese, that individual may be stratified separately within each of the applicable coarse cohorts. Alternately, a coarse cohort may be filtered before deploying SDS flow 10, e.g., by further segmenting the coarse cohort to recognize common but not universal comorbidities, such as diabetes and obesity. That is, the coarse cohort may be based on one or more than one diagnosis, symptom, or characteristic of the patient.

Flows and steps or sub-flows may be deployed sequentially. That is, the steps and sub-flows used need not all be calculated or recalculated at the same time. If individual steps or sub-flows cannot be completed, e.g., due to missing, out-of-date, contradictory, or non-sense entries in the available records, the other individual steps or sub-flows may be completed separately and may yield useful insights even without a complete analysis. As an example, impactability can be estimated from complexity or wellness, rather than complexity and wellness, if need be. Similarly, an estimate of impactability may be useful to a health service provider even if a reliable estimate of engageability cannot be determined. Estimates are made, refined, and combined with related estimates to provide a richer model of the individual for recommending health interventions, even if the best possible model cannot be deployed. The ability to work with incomplete data may be useful because, in many circumstances, even a cloud-based SDS system will not have access to all possible sources of useful information about an individual patient, e.g., because of older records that were never digitized; records in distinct systems that have not been identified as describing the same individual; records on systems inaccessible to one another due to network, privacy or security controls; and the like.

In some aspects, the invention relates to a method for stratifying a medical population. The method may comprise receiving data from two or more distinct information sources about a patient, such as EMRs maintained by different practitioners or health care organizations, health-related records that are not directly related to healthcare, community sources, social sources, patient surveys or interviews, and the like. The method may comprise applying sequential logic to calculate from the data one or more of a calculated disease burden 20 for a patient, a projected disease burden 30 for a patient, and a management risk 40 for the patient. The method may comprise using the data and the calculated risk or burden to predict an appropriate engagement strategy and/or health intervention for the patient. The method may comprise identifying one or more recommended health service workflows based on the engagement strategy. The method may comprise sending the recommended workflow(s) to one or more health service providers.

The method may further comprise calculating an impactability estimate for the patient. The data received in the method may be received from cloud-based databases containing unique information about the patient. The data received may include only new or changed data relative to previously received data. The distinct information sources may include data regarding the patient's healthcare and health-related services. The distinct information sources may include community and/or social data related to the patient. The calculated risk or burden may be based, at least in part, on information inferred from the community and/or social data. The recommended health service workflows may be recommended, at least in part, based on information inferred from the community and/or social data.

At least one of the recommended health service workflows may be automatically inserted into a patient encounter documentation system used by one or more health service providers. The recommended health service workflow may include periodic updates to the information used to calculate the risk or burden. The recommended health service workflow may include a request for confirmation of inferences drawn from the data received.

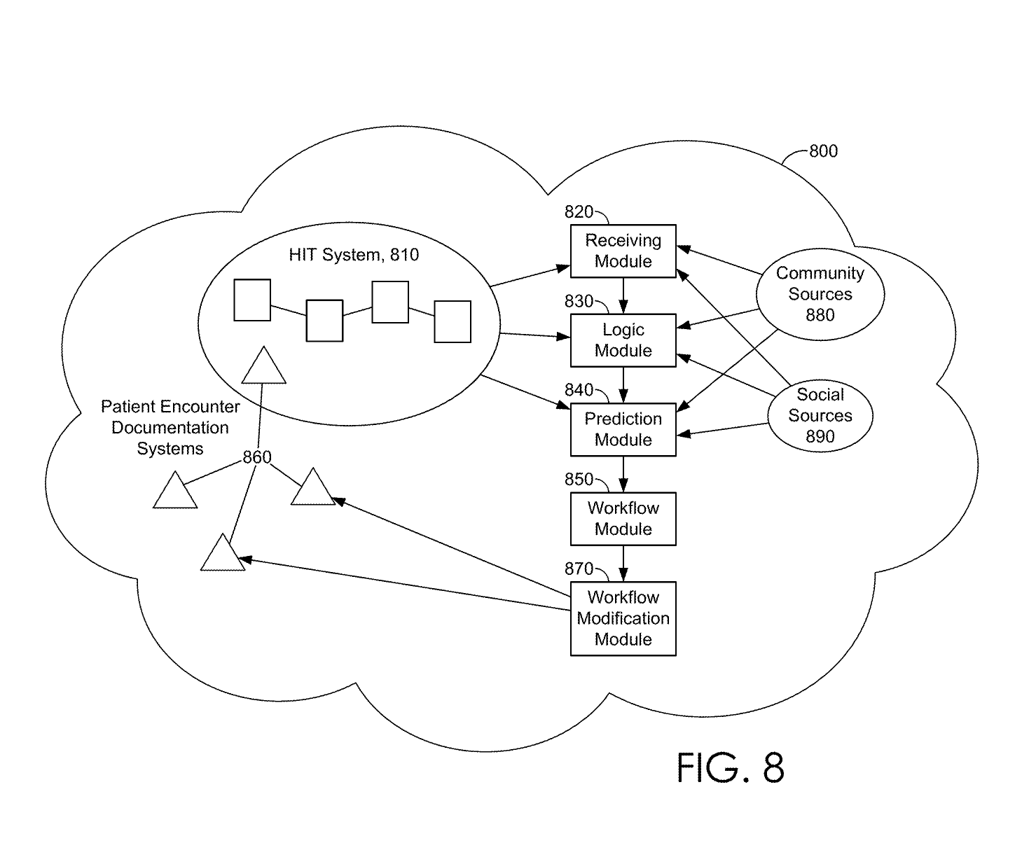

An exemplary stratification system 800 for stratifying a medical population is shown in FIG. 8. The system as shown is cloud-based, meaning that the system may reside on one or more servers which may be locally or remotely accessed by a plurality of users. It is also contemplated that the system could be implemented on a local area network (LAN) or direct access server or alternative computing device. The cloud environment may include two or more computing nodes, which may include processors, servers, storage media, or the like.

The stratification system 800 may comprise or be a component of a Health Information Technology (HIT) system 810. The HIT system 810 may, within a computing node or across two or more networked computing nodes, provide a processor; instructions for creating, maintaining, and accessing health records for individuals; and storage means for storing databases of health records, possibly to include images and other files as well as alphanumeric text. Various HIT systems are known in the art, and many variations are possible. HIT system 810 may be shared by a variety of health service professionals. That is, HIT system 810 may contain records from and/or provide access to health records to a variety of health service professionals, possibly in remote geographic locations (e.g., separate buildings, separate towns or cities, separate states, or even separate countries or continents).

Various aspects of stratification system 800 may receive, request, and/or send information to or from other aspects of the system. It should be understood that where stratification system 800 is implemented on a distributed network, with processing, data storage, and other computing functions possibly residing on a plurality of networked computing devices, any communication between or within systems, modules, databases, processors, or other elements of stratification system 800, including any external resources accessed by stratification system 800, may be direct or indirect. That is, if a module sends information to another module, that information may go directly from module A to module B, or may be transmitted to module B via one or more of modules C, D, E, F, etc. As an example, communications may be routed through a central control server 930. As another example, communications may be routed through a communications module (not shown) that coordinates the requesting, sending, and/or receiving of information by various aspects of stratification system 800.

Stratification system 800 may further comprise a receiving module 820. Receiving module 820 may be configured to receive data about a patient. The data may come from two or more distinct information sources. Receiving module 820 may receive data from other components of HIT system 810 and/or may receive data from other components of system 810 in response to requests from receiving module 820 for particular data, images, information, etc. Receiving module 820 may further request and/or receive information from resources external to HIT system 810, such as community sources 880 or social sources 890. External resources may be accessible on a network, whether the network is a LAN, the internet, or something else, and may contain data of potential relevance to an individual patient. Receiving module 820 may hold the data in short-term memory for processing by stratification system 800, may temporarily store the data in a database for data processing within stratification system 800, or may maintain a long-term database of data, whether as longitudinal records maintained for individuals, or as de-identified data for population-level analysis, or both.

Receiving module 820 may pass data to a logic module 830, or, alternately, logic module 830 may retrieve data from receiving module 820. Logic module 830 applies sequential logic to calculate from the data various estimates of wellness, complexity, management risk, impactability, and/or engageability. For example, logic module 830 may calculate a current burden 20 for a patient, a projected burden 30 for a patient, and/or a management risk 40 for a patient.

Logic module 830 may pass the calculated estimates to prediction module 840, or, alternately, prediction module 840 may retrieve from logic module 830 the calculated estimates. Prediction model 840, using the calculated estimates, may predict an appropriate engagement strategy for a particular patient. The engagement strategy may define the kinds of possible interventions projected to be efficient for a particular patient. For example, the engagement strategy may reflect guidelines on the kinds of interventions recommended for a particular patient (e.g., passive or nearly passive interventions for patients with low engagement), the number of interventions recommended for a particular patient (e.g., a high-engagement patient may be willing or able to attempt more changes at once than a lower-engagement patient), and/or the cost of interventions recommended for a particular patient (e.g., higher cost or higher resource interventions may be recommended for high impactability-high engagement patients).

Workflow module 850 may receive from and/or retrieve from prediction module 840 one or more engagement strategies. Workflow module 850 identifies recommended health service workflows for the patient based on the one or more engagement strategies. The health service workflows may involve administrative tasks, such as sending updates, reminders, referral information, or a request for information to a patient or caregiver. Alternately, or in addition, the health service workflows may involve health service tasks, such as ordering a laboratory test, performing a procedure, delivering a treatment or service, prescribing a medication, examining a patient, reviewing a patient's health service or medical record or records, preparing a plan for the patient, and the like, or combinations thereof. In addition to or instead of health service workflows, workflow module 450 may recommend non-health-related referrals (such as a referral to child care, to enable an adult to keep medical appointments), recommend changes in communication media (e.g., adopting telephonic communications with a patient with vision impairment, literacy challenges, or irregular access to mail or e-mail); or provide information about community or social resources that might be beneficial for the individual.

Health service providers associated with stratification system 800 may use a patient encounter documentation system 860. For healthcare providers, patient encounter documentation may be managed using electronic health records or related software, which may be integral to or separate from HIT system 810 and/or stratification system 800. Some health service providers may not use an electronic system for documenting patient encounters, or may use software which was not designed specifically for health records. For example, notes about patient appointments, goals, progress, or preferences may be stored using software designed for word processing, calendaring, creating tasks lists, managing contacts, or the like. If made accessible to stratification system 800, these informal patient encounter documentation systems can also be electronically searched, analyzed, and/or modified.

Stratification system 800 may include a workflow modification module 870. If one or more of the health service providers using stratification system 800 also uses an electronic patient encounter documentation system 860, workflow modification module 870 may insert one or more of the recommended health service workflows into at least one of the one or more patient encounter documentation systems 860. By inserting a recommended health service workflow, the recommended workflow is built in to the patient's next encounter with the health service provider, whose own system or device will include relevant instructions, requests, recommendations, or tasks associated with the recommended health service workflow. Alternately, or in addition, workflow module 850 and/or workflow modification module 870 may send recommended workflows to health service providers via any suitable communication method, including, without limitation, hard copy mail, e-mail, text messages, instant messaging, pager, voice messaging, iconographic alerts, or combinations thereof.

Stratification system 800 may include an inference engine, particularly, but not exclusively, if stratification system 800 is configured to receive data from external sources, such as community and/or social sources. The inference engine may draw connections between data in the patient's individual record, such as an address, zip code, reported hobbies, reported behaviors, etc., and data in the community and/or social sources, such as socioeconomic data for the patient's neighborhood or zip code, local athletic leagues, support groups, and the like. The inference engine may also draw inferences between different data points within the patient's individual record, such as related reports to or from different providers or at different times, which may provide an indication about status or trends in the patient's wellness, complexity, impactability, engageability, and/or management risk. The inference engine may draw inferences with reference to a medical knowledge model and/or a database of correlations between particular data points or kinds of data and patient wellness, complexity, impactability, engageability and/or management risk.

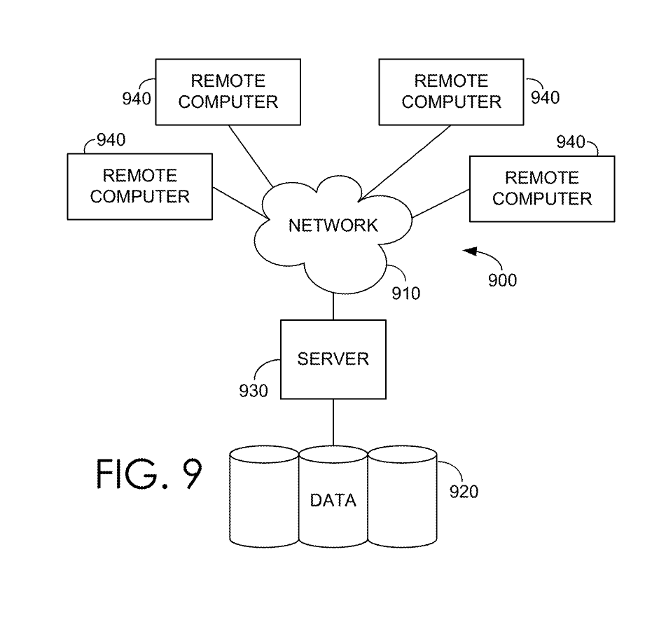

Stratification system 800 may be operated in an exemplary computing environment 900 as shown in FIG. 9. Exemplary computing environment 900 includes at least one general purpose computing device in the form of a control sever 930. Components of control server 930 may include, without limitation a processing unit, internal system memory, and a suitable system bus for coupling various system components, including database cluster 920, with the control server 930. The system bus may be any of several types of bus structures, including a memory bus or memory controller, a peripheral bus, and a local bus, using any of a variety of bus architectures. By way of example, and not limitation, such architectures include Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus.

The control server 930 typically includes therein, or has access to, a variety of computer-readable media, for instance, database cluster 920. Computer-readable media can be any available media that may be accessed by control server 930, and includes volatile and nonvolatile media, as well as removable and non-removable media. By way of example, and not limitation, computer-readable media may include computer-storage media and communication media. Computer-storage media may include, without limitation, volatile and nonvolatile media, as well as removable and non-removable media implemented in any method or technology for storage of information, such as computer readable instructions, data structures, program modules, or other data. In this regard, computer-storage media may include, but is not limited to, RAM, ROM, EEPROM, flash memory or other memory technology, CD-ROM, digital versatile disks (DVDs) or other optical disk storage, magnetic cassettes, magnetic tape, magnetic disk storage, or other magnetic storage device, or any other medium which can be used to store the desired information and which may be accessed by the control server 22. Computer-storage media may exclude signals per se. Computer-readable media may exclude signals per se.

Communication media typically embodies computer readable instructions, data structures, program modules, or other data in a modulated data signal, such as a carrier wave or other transport mechanism, and may include any information delivery media. As used herein, the term “modulated data signal” refers to a signal that has one or more of its attributes set or changed in such a manner as to encode information in the signal. By way of example, and not limitation, communication media includes wired media such as a wired network or direct-wired connection, and wireless media such as acoustic, RF, infrared, and other wireless media. Combinations of any of the above also may be included within the scope of computer-readable media. The computer-storage media discussed above and illustrated in FIG. 9, including database cluster 920, provide storage of computer readable instructions, data structures, program modules, and other data for the control server 930.

The control server 930 may operate in a computer network 910 using logical connections to one or more remote computers 940. Remote computers 940 may be located at a variety of locations in a medical or research environment, for example, but not limited to, clinical laboratories (e.g., molecular diagnostic laboratories), hospitals and other inpatient settings, veterinary environments, ambulatory settings, medical billing and financial offices, hospital administration settings, home health care environments, and clinicians' offices and the clinician's home or the patient's own home or over the Internet. Clinicians may include, but are not limited to, a treating physician or physicians, specialists such as surgeons, radiologists, cardiologists, and oncologists, emergency medical technicians, physicians' assistants, nurse practitioners, nurses, nurses' aides, pharmacists, dieticians, microbiologists, laboratory experts, laboratory technologists, genetic counselors, researchers, veterinarians, students, and the like. The remote computers 940 may also be physically located in non-traditional medical care environments so that the entire health care community may be capable of integration on the network. The remote computers 940 may be personal computers, servers, routers, network PCs, peer devices, other common network nodes, or the like, and may include some or all of the elements described above in relation to the control server 930. The devices can be personal digital assistants or other like devices.

Exemplary computer networks 910 may include, without limitation, local area networks (LANs) and/or wide area networks (WANs). Such networking environments are commonplace in offices, enterprise-wide computer networks, intranets, and the Internet. When utilized in a WAN networking environment, the control server 930 may include a modem or other means for establishing communications over the WAN, such as the Internet. In a networked environment, program modules or portions thereof may be stored and/or executed on the control server 930, in the database cluster 920, or on any of the remote computers 940. For example, and not by way of limitation, various application programs and/or data may reside on the memory associated with any one or more of the remote computers 940. It will be appreciated by those of ordinary skill in the art that the network connections shown are exemplary and other means of establishing a communications link between the computers (e.g., control server 930 and remote computers 940) may be utilized.

In operation, a user may enter commands and information into the control server 930 or convey the commands and information to the control server 930 via one or more of the remote computers 940 through input devices, such as a keyboard, a pointing device (commonly referred to as a mouse), a trackball, or a touch pad. Other input devices may include, without limitation, microphones, satellite dishes, scanners, or the like. Commands and information may also be sent directly from a remote healthcare device to the control server 930. In addition to a monitor, the control server 930 and/or remote computers 940 may include other peripheral output devices, such as speakers and a printer.

Many other internal components of the control server 930 and the remote computers 940 are not shown because such components and their interconnection are well known. Accordingly, additional details concerning the internal construction of the control server 930 and the remote computers 940 are not further disclosed herein.

Methods and systems of embodiments of the present invention may be implemented in a WINDOWS or LINUX operating system, operating in conjunction with an Internet-based delivery system. One of ordinary skill in the art will recognize that the described methods and systems can be implemented in any alternate operating system suitable for supporting the disclosed processing and communications. As contemplated, the methods and systems of embodiments of the present invention may also be implemented on a stand-alone desktop, personal computer, cellular phone, smart phone, PDA, or any other computing device used in a healthcare environment or any of a number of other locations. Nonetheless, when networked and/or programmed as described herein, the system does more than the individual, generic devices could do.

In some aspects, the invention relates to computer readable media comprising executable instructions which, when executed by a computer process, cause the processor to perform the calculations and steps described herein. For example, the executable instructions may cause the processor to receive data from two or more distinct information sources about a patient; apply sequential logic to calculate from the data one or more of a calculated burden for the patient, a projected burden for the patient, and a management risk for the patient; use the calculated burden or risk to predict an appropriate engagement strategy; identify one or more recommended health service workflows based on the engagement strategy; and send the recommended health service workflow or workflows to one or more health service providers. The instructions may further cause the computer to calculate an impactability estimate for the patient. The instructions may cause the computer to use the impactability estimate and the calculated burden or risk to predict an appropriate engagement strategy. At least one of the recommended health service workflows may include a request for a health service provider to update or confirm information about the patient.

It will be understood that certain features and subcombinations are of utility and may be employed without reference to other features and subcombinations. This is contemplated by and is within the scope of the claims.

Since many possible embodiments may be made of the invention without departing from the scope thereof, it is to be understood that all matter herein set forth or shown in the accompanying drawings is to be interpreted as illustrative and not in a limiting sense.

What is claimed is:

1. A method for stratifying a medical population, the method comprising:
receiving data from two or more distinct information sources about a patient;
applying sequential logic to calculate from the data one or more of a calculated burden for the patient, a projected burden for the patient, and a management risk for the patient;
using the data and the calculated risk or burden to predict an appropriate engagement strategy for the patient;
identifying one or more recommended health service workflows based on the engagement strategy; and
sending the recommended workflow or workflows to one or more health service providers.

2. The method of claim 1, further comprising calculating an impactability estimate for the patient.

3. The method of claim 2, wherein the data is received from cloud-based databases containing unique information about the patient.

4. The method of claim 3, wherein the received data includes only new or changed data relative to previously received data.

5. The method of claim 3, wherein the distinct information sources include data regarding the patient's healthcare and health-related services.

6. The method of claim 3, wherein the distinct information sources include community and/or social data related to the patient.

7. The method of claim 6, wherein the calculated risk or burden is based at least in part on information inferred from the community and/or social data.

8. The method of claim 6, wherein at least one of the recommended health service workflows is recommended at least in part based on information inferred from the community and/or social data.

9. The method of claim 8, wherein the at least one of the recommended health service workflows includes a request for confirmation of inferences drawn from the data received.

10. The method of claim 3, wherein at least one of the recommended health service workflows is automatically inserted into a patient encounter documentation system used by one or more health service providers.

11. The method of claim 10, wherein the at least one health service workflow includes periodic updates to the information used to calculate the risk or burden.

12. A system for stratifying a medical population, the system comprising:
an HIT system distributed across two or more networked computing nodes;
a receiving module for receiving data about a patient from two or more distinct information sources;
a logic module for applying sequential logic to calculate from the data one or more of a calculated disease burden for the patient, a projected disease burden for the patient; and a management risk for the patient;
a prediction module for predicting an appropriate engagement strategy for the patient based on the data; and
a workflow module for identifying and sending recommending health service workflows for the patient.

13. The system of claim 12, further comprising one or more patient encounter documentation systems used by one or more health service providers.

14. The system of claim 13, further comprising a workflow modification module for inserting one or more recommended health service workflows into at least one of the one or more patient encounter documentation systems.

15. The system of claim 12, comprising access to one or more sources of community and/or social data of potential relevance to the patient.

16. The system of claim 15, further comprising an inference engine which infers information about the patient from the community and/or social data.

17. Computer readable media, excluding signals per se, comprising executable instructions which, when executed by a computer processor cause the processor to:
receive data from two or more distinct information sources about a patient;
apply sequential logic to calculate from the data one or more of a calculated disease burden for the patient, a projected disease burden for the patient, and a management risk for the patient;
use the calculated burden or risk to predict an appropriate engagement strategy;
identify one or more recommended health service workflows based on the engagement strategy; and
send the recommended health service workflow or workflows to one or more health service providers.

18. The computer readable media of claim 17, wherein the instructions further cause the computer to calculate an impactability estimate for the patient.

19. The computer readable media of claim 18, wherein the instructions further cause the computer to use the impactability estimate and the calculated burden or risk to predict an appropriate engagement strategy.

20. The computer readable media of claim 17, wherein at least one of the recommended health service workflows includes a request for a health service provider to update or confirm information about the patient.
